(19) United States
(12) Patent Application Publication
(10) Pub. No.: US 2009/0108638 A1
(43) Pub. Date: Apr. 30, 2009

(54) DRIVE UNIT OF A MOVABLE VEHICLE COMPONENT

(76) Inventor: Fritz Wegener, Gilching (DE)

Correspondence Address: DICKINSON WRIGHT PLLC, 1875 Eye Street, NW, Suite 1200, WASHINGTON, DC, 20006, US

(21) Appl. No.: 11/995,583

(22) PCT Filed: Jul. 13, 2006
(86) PCT No.: PCT/DE2006/001214

§ 371 Date: Jun. 20, 2008

(30) Foreign Application Priority Data
Jul. 14, 2005 (DE) 102005033609.4

(51) Int. Cl. B60J 7/185

(52) U.S. Cl. 296/224

(57) ABSTRACT

The invention relates to a drive unit (15) of a movable vehicle component (1,3), particularly a soft top compartment cover of a convertible, which is connected to a locking device (21) and a bearing mechanism (6) of the movable component (3). In order to improve the moving process, the drive unit is joined to the locking device (21) via a gear unit (16, 20; 16′, 20′). Preferably, the gear unit increases the ratio at which the drive unit associated with the locking device travels especially by 3 to 5 while reducing the force transmission ratio accordingly.

The invention relates to a drive unit of a movable vehicle component, in particular a convertible top compartment cover of a convertible, said drive unit being connected to a bearing device of the movable component, and additionally to a locking device.

DE 103 13 496 B4 has disclosed a drive unit which is coupled, firstly, to a main link of the bearing device of a convertible top of a vehicle and, secondly, to a locking hook of a locking lever. The locking hook locks the convertible top in its put-away position. Since the driving force for the locking hook is tapped off directly at the drive unit formed as a hydraulic piston/cylinder unit, the locking kinematics or the locking lever is subjected to the full force of the piston/cylinder unit should the kinematics be blocked. The associated components of the locking kinematics therefore have to be dimensioned to be stable in accordance with the high forces, which results in comparatively heavy components.

If the driving force is to be tapped off at a different component of the driving kinematics, then there is the problem that the required closing distance for the locking hook or for a lock device is generally smaller than the movement distance to be covered by the kinematic component. A reduction of the movement therefore has to be undertaken, but this leads to an increase in the transmission of force, as a result of which, in the event of blocking, the loads on the locking or lock kinematics may be even greater than in the event of a direct connection to the piston/cylinder unit.

The invention is therefore based on the object of providing a drive unit which is mentioned at the beginning and which is improved in respect of the actuation of the locking device.

In the case of the drive unit which is mentioned at the beginning, the object is achieved, according to the invention, in that the drive unit is connected to the locking device via a transmission unit. The transmission unit permits the mutual adjustment or adaptation of the movement distances of the drive unit and the locking device, with the actuating forces of the drive unit also being reduced by this means. The transmission unit, which constitutes a reduction unit in respect of the forces, may comprise one component or more than one component, the components forming, for example, an articulation kinematic arrangement.

The movable component may be a convertible top compartment cover of a convertible, a frame bearing the convertible top compartment cover, a convertible hard top or convertible top roof of a convertible or else a different part of a vehicle or convertible which can be moved, for example, by means of a pivotably mounted link, and can be adjusted into two end positions and can be locked in at least one of the end positions.

Advantageous refinements of the invention are indicated in the subclaims.

According to a preferred configuration, it is provided that the transmission unit increases the transmission ratio of the movement distance, associated with the locking device, of the drive unit in particular by a factor of 3 to 5. The effect achieved by this is that a reduced and comparatively small movement distance of the drive unit is sufficient for a movement distance required by the locking device. If the need arises, the increase in the transmission ratio may also amount, for example, to a factor of 2 to 10, but is not restricted to these limit values. With the increase in the transmission ratio of the distance, a corresponding reduction of force is also obtained, and therefore the load exerted by the drive unit on the components of the locking device and on transmission elements between the drive unit and the locking device during a block of the movement is reduced.

The transmission unit preferably contains a transmission lever which, firstly, is mounted pivotably in a manner fixed on the vehicle and, secondly, is connected to the locking device or to an auxiliary component of the locking device in a joint, and on which the point of engagement of the driving device is arranged between said two articulation points or outside said articulation points. The transmission unit or the transmission lever can therefore be connected in between in different ways and can be adapted to a multiplicity of structural conditions. If the point of engagement of the driving device is arranged between the two abovementioned articulation points, the transmission lever transmits the driving movement in the same direction. If the point of engagement of the driving device is arranged on an arm which extends with respect to the pivot mounting of the transmission lever in a manner such that it lies opposite the coupling of the locking device, then the direction of the driving movement is reversed.

A blocking device is expediently provided which, when a component is moved in the direction of the second end position, prevents the drive unit from moving back. A defined and play-free movement of the component is therefore possible even if there is an undesirable application of force to the component during its adjustment. The blocking device can interact with a bearing or adjustment device of the component, and it can in particular be activated by it. The blocking device preferably contains a blocking element which is arranged on the locking device and, in particular, on a lock hook of the locking device and can be brought into blocking engagement with a blocking part arranged on the adjustment device of the component.

The drive unit is explained in more detail below using two exemplary embodiments and with reference to the drawing, in which:

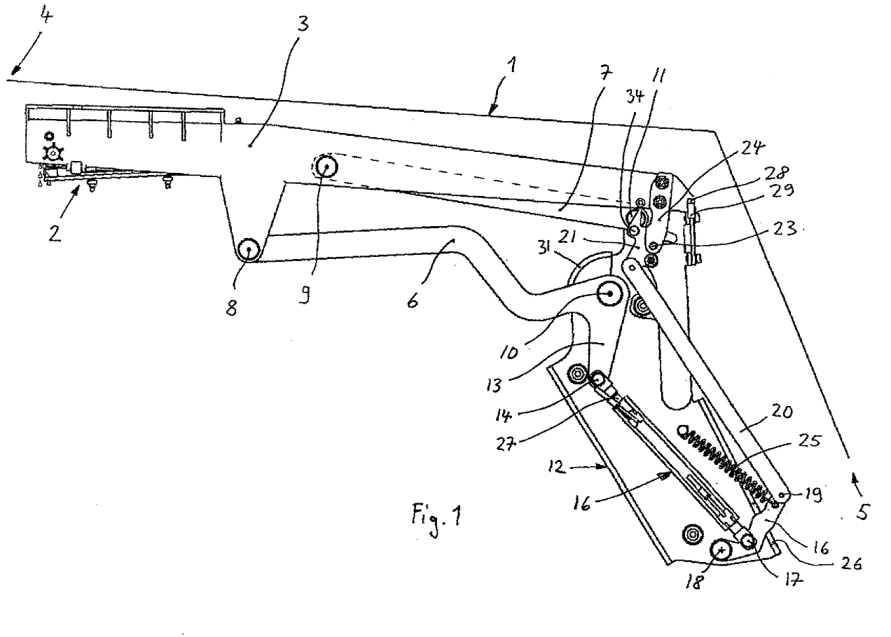

FIG. 1 shows, in a lateral plan view, a drive unit of a frame of a convertible, the frame being arranged in its closed position and supporting a convertible top compartment cover;

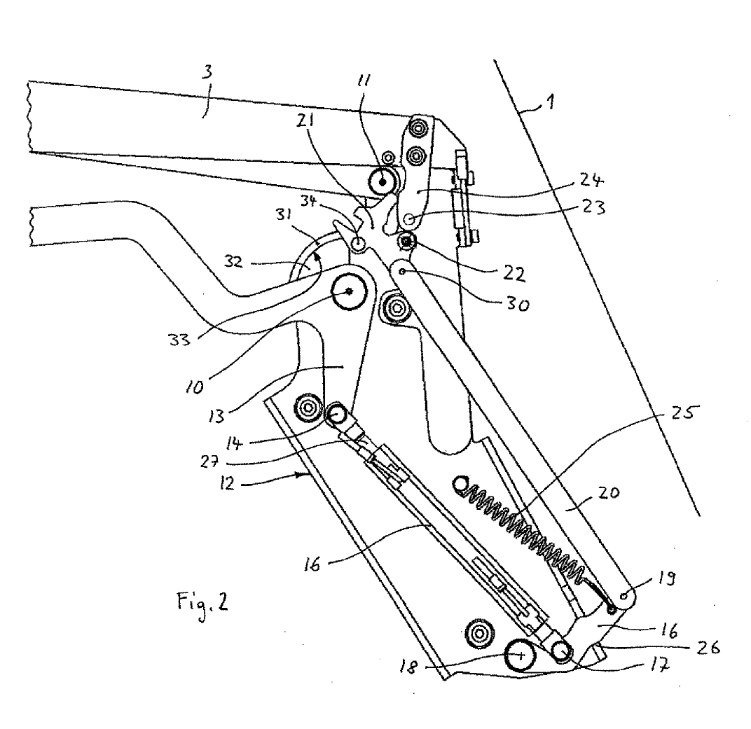

FIG. 2 shows, in a lateral plan view, the drive unit after the unlocking of a locking device of the frame;

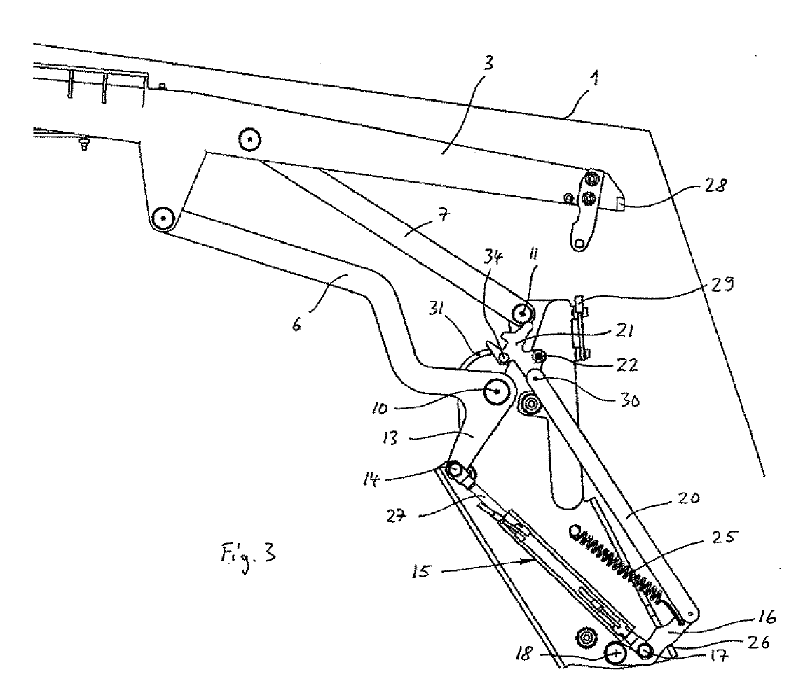

FIG. 3 shows, in a lateral plan view, the drive unit together with the frame of the convertible top compartment cover in an intermediate position during the opening of the frame and convertible top compartment cover;

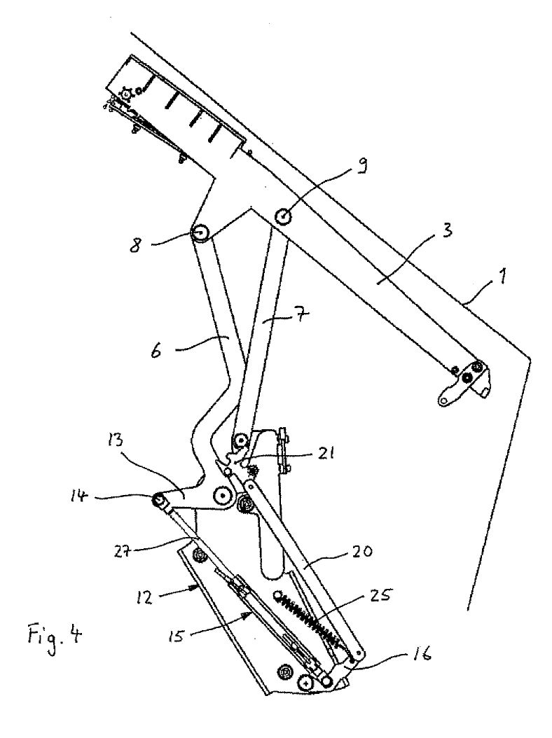

FIG. 4 shows, in a lateral plan view, the drive unit in the rearwardly pivoted open position of the frame and convertible top compartment cover;

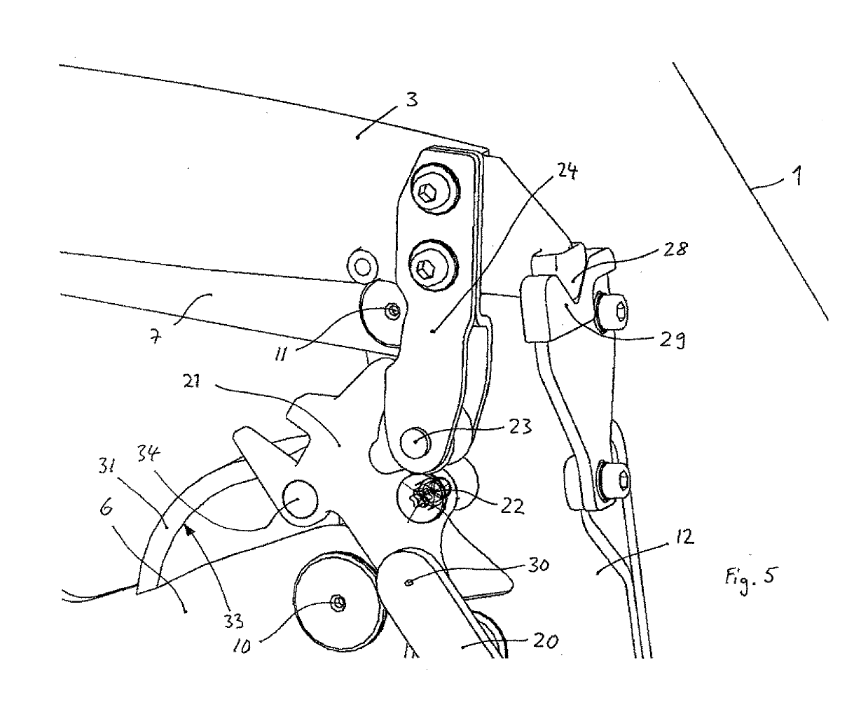

FIG. 5 shows, in a perspective view and in an enlarged illustration, the locking device in a position according to FIG. 2;

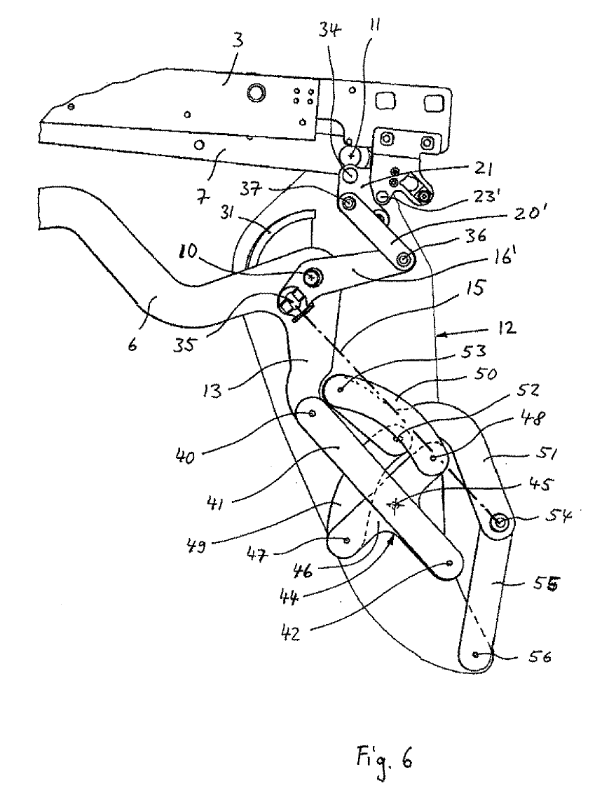

FIG. 6 shows, in a lateral plan view, a second exemplary embodiment of the drive unit with the frame and convertible top compartment cover arranged in the closed position;

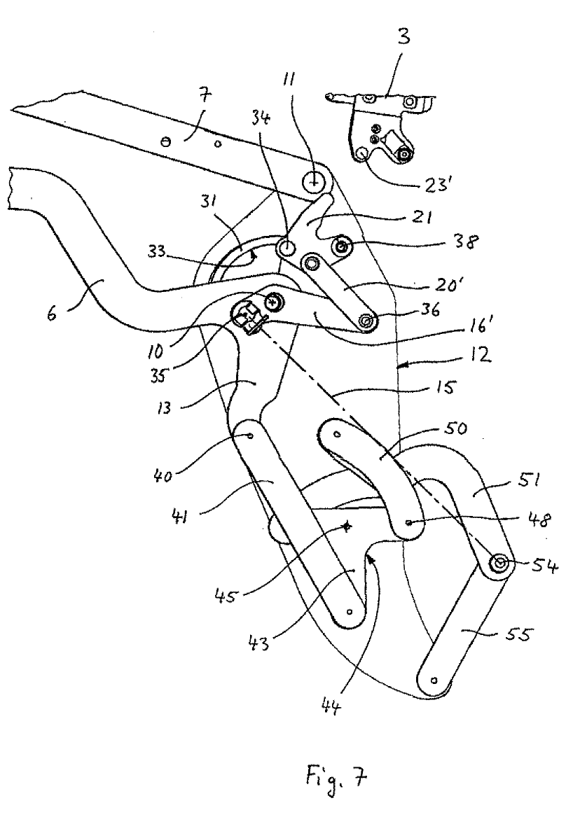

FIG. 7 shows, in a lateral plan view, the second exemplary embodiment of the drive unit in a first intermediate position during the pivoting-up of the frame and convertible top compartment cover;

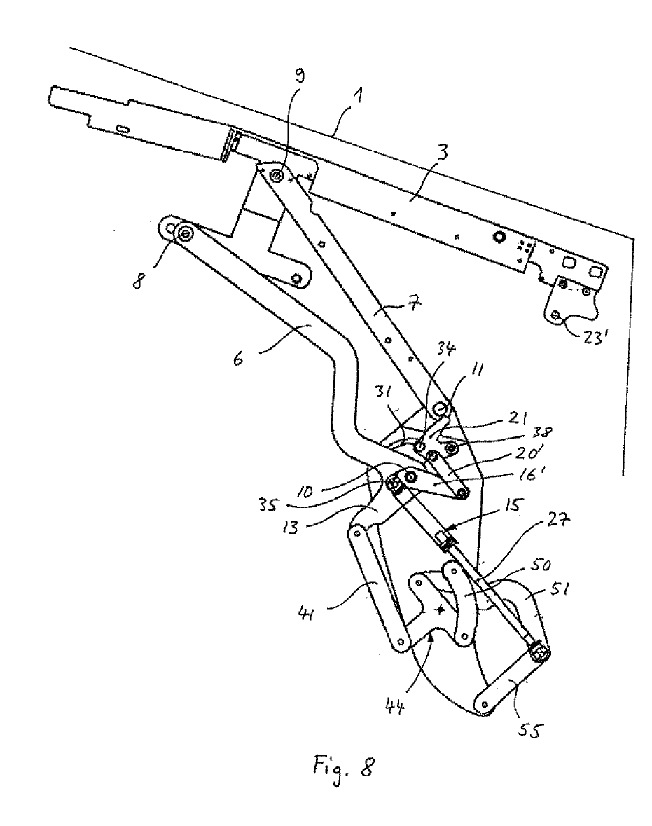

FIG. 8 shows, in a lateral plan view, the drive unit in the intermediate position shown in FIG. 7; and

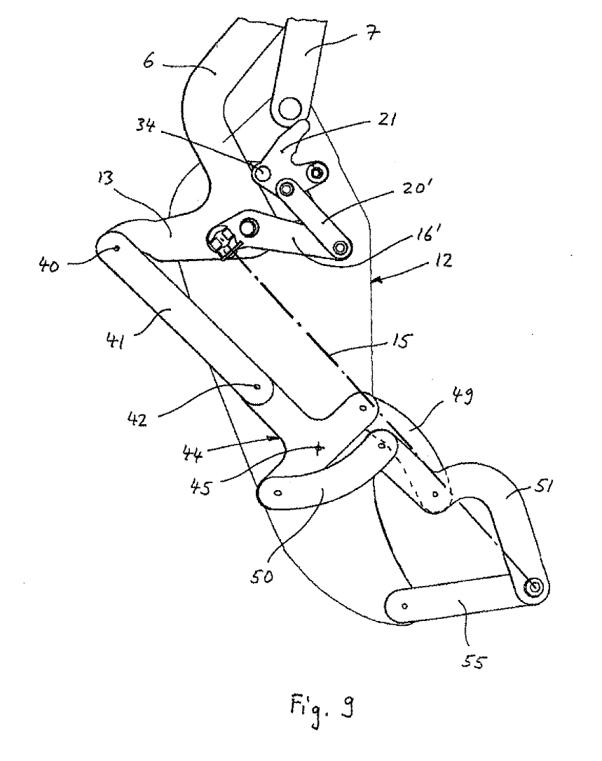

FIG. 9 shows, in a lateral plan view, the drive unit in an end position with the frame and convertible top compartment cover open.

A convertible top compartment cover 1 of a convertible (not illustrated) is mounted by means of a respective articulation device 2 (not illustrated specifically) on both sides of lateral, front frame parts of a frame 3 which is pivoted to the rear before the collapsible or folding roof is put away in a rear convertible top storage space such that the convertible top compartment cover 1 which is fixed to said frame is raised at its front edge 4 and opens up a passage opening for the collapsible or folding roof which is to be put away and which, in particular, can be a hard top roof or a convertible top roof. The convertible top compartment cover 1 may also serve as a trunk cover by, when the frame 3 is fixed to the vehicle body, being pivoted out of its closed position with its rear edge 5 relative to the frame 1 or the vehicle body and therefore opening up a loading opening of the trunk. DE 44 45 944 C1 basically discloses a convertible top compartment cover of this type which is supported auxiliary frame mounted on the vehicle rear in a manner such that it can pivot about a pivot axis fixed on the bodywork.

The frame 3 of the convertible top compartment cover 1 is mounted pivotably on both sides of the vehicle body by means of a respective main link 6 and an auxiliary link 7 which form a four-joint mechanism together with the joints 8 and 9 on the frame 3 and the joints 10 and 11 on a bearing plate 12 fixed on the vehicle body. The frame 1 is, for example, of U-shaped design such that it opens at the front in accordance with the auxiliary frame disclosed in DE 44 45 944 C1.

The main link 6 has a bent extension 13 which extends beyond the joint 8, which forms a pivot or bearing axis, with a drive unit in the form of a hydraulic piston/cylinder unit 15 being coupled to the end side of the extension in a joint 14. The piston/cylinder unit 15 is supported at the other end on a transmission lever 16 in a joint or articulation point 17 which is arranged on the bearing plate 12 between the pivot mounting 18 of the transmission lever 16 and its opposite end to which a connecting rod 20 is coupled in a joint 19. The connecting rod 20 extends upward to a lock hook 21 of a locking device which fixes the frame 3 in its end position or closed position on the bodywork or on the bearing plate 12. The lock hook 21 is mounted pivotably about a pivot axis 22 on the vehicle body and engages behind a bolt 23 which is fastened to a support part 24 which protrudes downward from the frame 3.

A tension spring 25 is fastened, firstly, to the transmission lever 16 in the vicinity of the joint 19 of the connecting rod 20 and, secondly, to the bearing plate 12 and prestresses the transmission lever 16 and therefore the locking device into a closed position of the locking device. A stop 26 which is fixed on the vehicle body and is formed, for example, on the bearing plate 12 restricts the pivoting distance of the transmission lever 16 in the opening direction counter to the direction of force of the tension spring 25.

In the closed position of the convertible top compartment cover 1 and of the frame 3 (see FIG. 1), the piston/cylinder unit 15 is unpressurized when the piston rod 27 is retracted. The tension spring 25 uses the connecting rod 20 to clamp the lock hook 21 in its locking position in which it keeps the bolt 23, which may be enclosed by a sleeve, locked in a manner fixed on the vehicle body. A downwardly tapering guide part 28 of the frame 3 is accommodated in a centered manner in a corresponding receptacle 29 on the vehicle body, thus forming a y-z support (in the x-y-z coordinate system) of the frame 3 while the lock hook 21 permits an x support.

In order to open the convertible-top compartment cover 1 and in order to pivot up the frame 3, the piston/cylinder unit 15 is subjected to pressure such that it extends by extension of its piston rod 21. The piston or expansion force first of all causes the transmission lever 16 to pivot downward counter to the force of the tension spring 25 as far as the stop 26, since, owing to the weight of the frame 3 and the convertible-top compartment cover 1, the main link 6 exerts a counterforce on the piston/cylinder unit 15, which counterforce is greater than the adjustment force required to pivot the transmission lever 16 and the locking device coupled thereto.

The piston/cylinder unit 15 is coupled with its point 17 substantially closer to the pivot mounting 18 of the transmission lever 16 than to the joint 19 of the connecting rod 20, and therefore, in accordance with the design undertaken, for example an increase in the transmission ratio of the movement distance of the piston/cylinder unit 15 in relation to the connecting rod 20 by a factor of 4 is produced. For a certain length of the adjustment distance of the connecting rod 20, for example for 20 mm, only a 5 mm movement distance of the piston/cylinder unit 15 is therefore required. The increase in the transmission ratio of the movement distance results at the same time in a corresponding reduction of the actuating force of the piston/cylinder unit 15 on the connecting rod 20 to the same extent, as a result of which the components can be dimensioned to be smaller and therefore can be constructed to be lighter. Furthermore, in the event of the movement of the main link 6 or of the locking device, the high adjustment forces of the hydraulic piston/cylinder unit 15 are reduced by the extent of the transmission ratio at the locking device, thus enabling more serious damage to be avoided.

A joint 30 which connects the connecting rod 20 to the lock hook 21 is arranged on said lock hook in such a manner that, on account of the movement distance of the connecting rod 20, the lock hook 21 can execute the required pivoting movement between the open position and the closed position.

When the lock hook 21 is unlocked (see FIG. 2), the transmission lever 16 or else another component of the locking kinematics bears on a or on the stop 26 such that, via the joint 14, the further extension of the piston rod 27 adjusts the main link 6 in the opening direction (movement from FIG. 2 to FIG. 3).

An annular segment 31 which is concentric with respect to the bearing axis 10 is fastened to the main link 6 in the region of its bearing axis 10 by means of a supporting plate 32, which is attached fixedly to the main link 6, in such a manner that, by means of its inner supporting path 33, the annular segment 31 begins, in the position of FIG. 2, to engage behind a supporting bolt 34 protruding from the lock hook 21 laterally in relation to the bearing plate 12. By means of the annular segment 31, which forms a blocking guide slot, the lock nook 21 is blocked against pivoting in the closing direction and, as a consequence thereof, that end of the piston/cylinder unit 15 which is mounted on the transmission lever 16 is held by it in a positionally fixed manner even if an undesirable load or counterforce acts on the opening convertible top compartment cover 1 and/or frame 3.

Further extension of the piston rod 27 pivots the main link 6 into its open end position (movement from FIG. 3 to FIG. 4) in which the frame 3 is pivoted together with the convertible top compartment cover 1 to the rear and therefore an opening for the retraction or extension or the convertible top is opened up. The transmission lever 16 bears against the stop 26, and the lock hook 21 provides an opposite support via its engagement on the annular segment 31. The lower articulation point 17 of the piston/cylinder unit 15 is therefore kept in a fixed position. If, in the open position, the frame 3 together with the convertible top compartment cover 1 assumes a position beyond the dead center with respect to its mounting, i.e. if the center of gravity of the unit comprising frame 3 and convertible top compartment cover 1 has moved to the rear via the bearing axis and the unit bears, for example, against a support, the piston/cylinder unit 15 can be switched in an unpressurized manner.

The unpressurized switching of the piston/cylinder unit 15 may also take place in the closed position according to FIG. 1. By means of the tension spring 25, the locking device and the lock hook 21 are then prestressed into the closed position such that the weight of the cylinder housing of the piston/cylinder unit 15 means that the lock hook 21 cannot open even when shaken during the driving mode.

The closing of the convertible top compartment cover 1 and of the frame 3 takes place in an opposite sequence of movement by retraction of the piston rod 27 of the piston/cylinder unit 15. In this case, upon further retraction of the piston rod 27 out of the position according to FIG. 2, the transmission lever 16 is pivoted upward (in the anticlockwise direction according to FIG. 2) as soon as the supporting bolt 34 is released from the blocking guide slot or the annular segment 31, and the lock hook 21, in engagement with the bolt 23, draws the frame 3 into its end position, with the guide part 28 being accommodated centrally in the receiving part 29.

By designing the drive unit together with the transmission unit, the level of force and the movement distance for the locking device and the lock hook 21 can be freely selected. The lower forces to be transmitted mean that simpler and low-wearing mountings of the components can be used. The blocking strength of the locking device can be obtained with simply constructed and light parts.

In a second exemplary embodiment of the drive unit (see FIGS. 6 to 9), the piston/cylinder unit 15 (illustrated schematically in the form of a chain-dotted line in FIGS. 6 and 7) is coupled in a joint 35 to a transmission lever 16′ which is mounted in the joint 10 in a manner such that it can be pivoted coaxially with respect to the main link 6. The transmission lever 16′ is coupled in a joint 36 to a connecting rod 20′ which, in turn, is coupled in a joint 37 to a lock hook 21′ which is coupled pivotably in a pivot axis 38 to the bearing plate 12 and is provided for locking engagement with a locking part, such as, for example, a locking bolt 23′ which is fastened to the rear edge region of the frame 3. The transmission lever 16′ is formed with two arms with respect to the joint 10, with the coupling of the piston/cylinder unit 15 being arranged in the joint 35 on the short arm and the joint 36 for the connecting rod 16′ being arranged opposite on the long arm, and the distance between the joint 36 and the joint 10 forming the pivot axis being a multiple of the distance between the joint 35 of the coupling of the piston/cylinder unit 15 and the joint 10.

A coupling rod 41 is coupled in a joint 40 on the end side of the bent extension 13 of the main link 6, which extension extends beyond the joint 10 forming a bearing axis, said coupling rod, in turn, being coupled pivotably in a joint 42 to a laterally protruding arm 43 of an approximately T-shaped crank 44. The crank 44 is mounted pivotably on the bearing plate 12 in an axis of rotation 45 and at its base 46 contains two joints 47 and 48 which lie opposite each other with respect to the axis of rotation 45 and to which a respective cross link 49 and 50 of a cross link mechanism is coupled. The two cross links 49 and 50 are coupled in a cross link arrangement at the other end to a driving link 51 in joints 52 and 53 which are spaced apart from each other, with the joint 53 being arranged on the one end of the driving link 51 which is coupled at its other end in a joint 54 to an oscillating lever 55 which, in turn, is coupled pivotably to the lower end of the bearing plate 12 in a joint 56.

All of the links are formed as flat, plate-like components, and therefore the adjustment device is of very slim construction in the transverse direction of the vehicle.

In the closed position of the frame 3 and of the convertible top compartment cover 1 (see FIG. 6), the piston rod 27 of the piston/cylinder unit 15 is retracted, and, via the driving link 51 and the cross position in which the longitudinal axis of the coupling rod 41 runs essentially through the axis of rotation 45 of the crank 44. The coupling rod 41 on the crank 44 is therefore located in a dead center position in which a force introduced into the coupling rod 41 by the main link 6 does not produce any movement of the crank 44. The piston/cylinder unit 15 is accordingly relieved from force in the closed position.

The three joints 52, 53 and 54 of the driving link 51 lie, for example, approximately on a straight line, but the driving link 51 is curved or bulged between the joints 52 and 54 such that, in the end or closed position illustrated in FIG. 9, the driving link 51 engages in a space-saving manner around that end of the crank 44 which contains the joint 48, and therefore the crank 44 and the driving link 51 can be arranged in a space-saving manner essentially in a pivoting plane.

The locking kinematics is arranged in a locking position and keeps the locking bolt 23′ of the frame 3 locked by means of the lock hook 21.

In order to pivot up the convertible top compartment cover 1 at its front edge 4, the piston/cylinder unit 15 is actuated and its increase in length on account of the extending piston rod 27 first of all causes the transmission lever 16′ to be pivoted in the clockwise direction (according to FIG. 6) and the lock hook 21 to be opened via the coupling 20′, with the locking bolt 23′ being released. The initial expansion of the piston/cylinder unit 15 first of all actuates the locking kinematics, since a comparatively small force is required for this, whereas, due to the weight of the convertible top compartment cover 1 and the frame 3, a shifting of the crank 44 or of the driving link 51 coupled via the cross links 49 and 50 requires a greater force.

The different distances of the joints 35 and 36 from the pivot, axis 10 of the transmission lever 16′ bring about an increase in the transmission ratio of the adjustment or unlocking distance, and therefore a small increase in length of the piston/cylinder unit 15 is sufficient in order to unlock the locking kinematics or the lock hook 21. Accordingly, the force of the piston/cylinder unit 15 is reduced.

When the lock hook 21 is unlocked, it or another component of the locking kinematics bears against a stop, and therefore further extension of the piston rod 27 via the joint 54 adjusts the driving link 51 in the opening direction (movement from FIG. 6 to FIG. 7) and said driving link pivots the crank 44 via the two cross links 49 and 50. Via the coupling rod 41 which is connected in between, the main link 6 is pivoted about its bearing axis 10, with the rotating crank 44 first of all only bringing about a small movement of the coupling rod 41 at the joint 40 and therefore an initially slow pivoting of the main link 6. However, this reduction of the speed of movement results, as a desirable secondary effect, in the transmission of a high adjustment or opening force to the main link 6.

The supporting bolt 34 of the lock hook 21 is now engaged behind by the inner supporting path 33 of the annular segment 31, corresponding to the first exemplary embodiment, and therefore the lock hook 21 is prevented from pivoting back in the closing direction and, as a result thereof, that end of the piston/cylinder unit 15 which is mounted on the transmission lever 16′ is held there in a fixed position even if an undesirable load or counterforce acts on the opening convertible top compartment cover 1 and frame 3.

Further extension of the piston rod 27 moves the drive unit into the position which is illustrated in FIGS. 7 and 8 and in which, owing to the approximately right-angled position of the arm 43 of the crank 44 and the coupling rod 41 with respect to each other, the movement of the piston rod 27 produces a maximum adjustment movement of the coupling rod 41 and therefore a maximum adjustment speed of the main link 6.

During the further course of opening, the crank 44 passes through a pivoting angle region in which the joint 42, which is arranged on the arm 43, of the connecting straight line between the axis of rotation 45 of the crank 44 and the joint 40 approaches the extension 13 of the main link 6. The speed of the adjustment movement of the coupling rod 41 is therefore significantly reduced again until, finally, it becomes zero in the position illustrated in FIG. 9. In the movement end position, the coupling rod 41 and the crank 44 are again located in a dead center position in which an introduction of force to the coupling rod 41 by the main link 6 does not cause any adjustment of the crank 44. The crank 44 has therefore been pivoted about a pivoting angle of approximately 180°.

A favorable transmission profile can be obtained with this adjustment device. By means of the drive unit which has a cross link mechanism, the force profile is optimized and the movement distance of the piston/cylinder unit 15 is shortened, thus also shortening the adjustment time. The convertible top compartment cover 1 or the frame 3 is therefore moved gently into its two end positions, with a high adjustment or supporting force being provided.

In the end position according to FIG. 9, the crank 44 may also be pivoted by approximately 1° to 3° beyond the dead center position in order to achieve secure locking of the drive unit, when the convertible top compartment cover 1 and frame 3 are open.

The closing of the convertible top compartment cover 1 and frame 3 takes place in an opposite sequence of movement by contraction of the piston/cylinder unit 15. Of course, the piston/cylinder unit 15 may also be supported on the bearing plate 12 via an articulation device without a cross link mechanism connected in between.

### LIST OF REFERENCE NUMBERS

1 Convertible compartment cover

2 Articulation device

3 Frame

4 Front edge

5 Rear edge

6 Main link

7 Auxiliary link

8 Joint

9 Joint

10 Joint

11 Joint

12 Bearing plate

13 Extension

14 Joint

15 Piston/cylinder unit

16 Transmission lever

17 Articulation point

18 Pivot mounting

19 Joint

20 Connecting rod

21 Lock hook

22 Pivot axis

23 Bolt

24 Support part

25 Tension spring

26 Stop

27 Piston rod

28 Guide part

29 Receptacle

30 Joint

31 Annular segment

32 Support plate

33 Supporting path

34 Supporting bolt

35 Joint

36 Joint

37 Joint

38 Pivot axis

40 Joint

41 Coupling rod

42 Joint

43 Arm

44 Crank

45 Axis of rotation

46 Base

47 Joint

48 Joint

49 Cross link

50 Cross link

51 Driving link

52 Joint

53 Joint

54 Joint

55 Oscillating lever

56 Joint

1. A drive unit of a movable vehicle component, in particular a convertible top compartment cover of a convertible, said drive unit being connected to a bearing device of the movable component and additionally to a locking device, characterized in that the drive unit is connected to the locking device via a transmission unit.

2. The drive unit of claim 1, characterized in that the transmission unit increases the transmission ratio of the movement distance, associated with the locking device, of the drive unit in particular by a factor of 3 to 5 with a corresponding reduction of force.

3. The drive unit of claim 1, characterized in that the transmission unit contains a transmission lever which, firstly, is mounted pivotably in a manner fixed on the vehicle and, secondly, is connected to the locking device or to an auxiliary component of the locking device, and on which the point of engagement of the driving device is arranged between said articulation points or outside said articulation points.

4. The drive unit of claim 1, characterized in that the locking device 21 is prestressed in the closing direction.

5. The drive unit of claim 4, characterized in that the locking device is prestressed by a spring which acts on the transmission lever or a further component of the locking device, in particular a connecting rod.

6. The drive unit of claim 1, characterized in that, on the locking side, at least one stop which is fixed on the vehicle is provided in one of the directions of movement of the drive unit.

7. The drive unit of claim 1, characterized in that the transmission lever can be pivoted between two stops fixed on the vehicle.

8. The drive unit of claim 1, characterized in that, in a starting position or first end position of the component 3, the drive unit first of all actuates the locking device and subsequently moves the component.

9. The drive unit of claim 1, characterized in that the initial actuation of the locking device is controlled by the weight of the component.

10. The drive unit of claim 1, characterized in that a blocking device is provided which, when a component is moved in the direction of the second end position, prevents the drive unit from moving back.

11. The drive unit of claim 10, characterized in that the blocking device interacts with the adjustment device of the component and, in particular, is activated by it.

12. The drive unit of claim 10, characterized in that the blocking device has a blocking element which is arranged on the locking device and, in particular, on a lock hook of the locking device and can be brought into blocking engagement with a blocking part arranged on the adjustment device of the component.

13. The drive unit of claim 1, characterized in that the component is supported on the vehicle side by means of a main link, in particular in a four-joint arrangement.

14. The drive unit of claim 1, characterized in that a lock hook of the locking device draws the component in the closed position into a y-z support fixed on the vehicle.

15. The drive unit of claim 1 characterized in that the component is a frame which is supported in a movable manner on the vehicle body via an articulation device, in particular a four- or multi-joint mechanism, and on which a convertible top compartment cover is pivotably mounted.

16. The drive unit of claim 1, characterized in that it is a linear adjustment unit and, in particular, a hydraulic piston-cylinder unit.

17. The drive unit of claim 1, characterized in that a cross link mechanism is connected between the drive unit and the locking device.

18. The drive unit of claim 17, characterized in that one link of the bearing device of the movable component is coupled via a coupling rod to a rotatably mounted crank which is connected via two cross links to a driving link which can be moved by the drive unit

19. The drive unit of claim 18, characterized in that the crank is mounted rotatably between the two articulation points of the cross links and has a laterally protruding arm to which the coupling rod is coupled.

20. The drive unit of claim 18, characterized in that, in the one end position and/or in the other end position of the component, the coupling rod and the crank are arranged in a dead center position in which the crank maintains its position if a force is introduced by the component to the coupling rod.

21. The drive unit of claim 17, characterized in that the driving link is coupled to an oscillating lever which is coupled pivotably to a positionally fixed bearing part.

22. The drive unit of claim 21, characterized in that the drive unit firstly acts on the connecting joint between the oscillating lever and the driving link and secondly is at least temporally supported in a positionally fixed manner.
